(19) United States
(12) Patent Application Publication
(10) Pub. No.: US 2007/0052725 A1
(43) Pub. Date: Mar. 8, 2007

(54) User interface for simultaneous experiencing multiple application pages

(75) Inventors: Bojana Ostojic, Seattle, WA (US); Christopher A. Glein, Seattle, WA (US); Mark R. Gibson, Seattle, WA (US); William H. Vong, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/217,492

(22) Filed: Sep. 2, 2005

(51) Int. Cl. G09G 5/00

(52) U.S. Cl. 345/625

(57) ABSTRACT

A method and system for displaying a menu to a user via a user interface. The processor with instructions identifies an image type corresponding to a displayed image. Upon this determination, the processor selects a mask corresponding to the image type. Thereafter, the processor modifies the displayed image using the selected mask. As a result, a user can access other applications via an overlay menu while experiencing a current page or current application. Furthermore, a user select menu items and navigate through a menu while viewing an image in the background via a semi-transparent mask.

### CROSS-REFERENCE TO RELATED APPLICATIONS

Not applicable

### STATEMENT REGARDING FEDERALLY SPONSORED RESEARCH OR DEVELOPMENT

Not applicable

### BACKGROUND

Multi-media centers are commonly found in homes due to the advancements in computing technologies. Now, there is a large assortment of user applications for displaying media content in the form of audio CD galleries, DVD galleries, etc. For example, a user has the option of playing a music CD or watching a DVD via a multimedia center in conjunction with his or her personal computer (PC). However, a user cannot simultaneously utilize a current page and view other page selections via a menu without opening a new menu page.

What is needed is a system and method that allows a user to access an application while simultaneously experiencing additional pages or applications. In accessing the application, the system and method should provide a user the ability to select various options while retaining the view of the background page or application. The system and method should also provide for improved visibility and context for displayed items while accessing the application.

### SUMMARY

In an embodiment, the invention provides a method and user interface for accessing an application via an overlay menu while experiencing another current page or current application. The overlay menu can be invoked over any type of displayed image, allowing a user to access one or more items displayed in the menu. In another embodiment, a mask can be overlaid on at least a portion of the displayed image. Optionally, animations can be used during overlay of the menu to provide further contrast between the overlay menu and the displayed image.

### BRIEF DESCRIPTION OF THE DRAWINGS

FIG. 1 is a flowchart illustrating an overview of a system in accordance with an embodiment of the invention;

FIG. 2 is a computer system illustrating an overview of a system in accordance with an embodiment of the invention;

FIG. 3 is a block diagram illustrating an overview of a system in accordance with an embodiment of the invention.

### DETAILED DESCRIPTION

I. Overview

In an embodiment, the invention provides a quick venue for allowing a user to access other applications via an overlay menu while experiencing a current page or current application. The invention further provides a multi-planar user interface so that the user does not have to leave the current page or application in order to search other options that the user may be interested in. The multi-planar user interface can include a displayed image that can be text data, image data, html data, or any other type of data that can be conveniently displayed. The displayed image can also include a selected mask that corresponds to an image type. The selected mask can be overlaid on a portion of the displayed image. Additionally, the displayed image can include a menu that has menu items for selection by a user.

In another embodiment, the user interface enables a user to select menu items and navigate through a menu while viewing an image in the background via a semi-transparent mask. A semi-transparent mask can include any type of mask that can be applied over an image and allows the image to be seen while the mask is applied over the image. The semi-transparent mask also acts as an overlay to the current page or current application. The user interface can include: a menu mask that is laid over a displayed image; a first set of menu items that is selectable by a user; and a second set of menu items that is selectable by a user. Additionally, the second set of menu items can correspond to at least one menu item of the first set of menu items.

In still another embodiment, a system is provided that includes a magnifier module that magnifies the selected menu item by providing a motion sequence of frames of an animation when the user selects the one or more menu items from a first set of menu items. Additionally, the sequence divides one or more menu items between a first plane and a second plane and animates the first and second planes moving away from each other in three dimensional space.

In yet another embodiment, a system is provided that can bring focus to user interface objects in the gallery in the foreground and can push or tilt a gallery space askew in the background along the z-axis. Additionally, this can apply to pivot menus and insets such as PIP (picture in picture).In an embodiment, the invention provides an integrated method and system for displaying a menu as an overlay over existing displayed images. In an another embodiment, the invention further provide a multi-planar user interface for a data processing device for interaction by a user via remote control or other extended control device.

In another embodiment, a method is provided for displaying a menu to a user via a graphical user interface (GUI). In such an embodiment, there are multiple steps for effectively achieving such result with enhanced-usability animations. These steps include, but are not limited to: identifying an image type corresponding to a displayed image; selecting a mask corresponding to the image type; and modifying the displayed image with the selected mask. This embodiment further enables a user to view, navigate, and select menu items while being able to still view a displayed image in the background. For example, a user could scroll through a Start Menu with multiple software applications while watching a movie being played in the background.

Furthermore, according to an embodiment, a user can feel a sense of depth in the user interface by manner of the enhanced-usability animations. Part of this effect is achieved because the user interface is capable of being constructed in a three way dimensional space. That is, while the user interface might be displayed on a two-dimensional display device such as a monitor or TV, the user interface may be constructed in a 3D graphical space having X, Y, and Z dimensions, as well as have an alpha channel, a, to provide transparency according to certain features of the user interface. Using the Z-dimension allows the user interface to have more information on the screen while still providing the information in a large enough size to be visible from farther away than a traditional 2-Foot user interface, because information can be presented with varying Z-values, as well as with varying X and Y values.

II. Displaying a Menu to a User

In an embodiment, a menu can be displayed to a user while that user views and runs another software application. Preferably, this menu or overlay is a Start Menu or Details page. Upon a signal sent from a control device such as a remote control device, a user interface is initiated. As a result, a processor with instructions from a software module stored therein identifies an image type corresponding to a displayed image. In an embodiment, the processor determines whether the displayed image is text data or image data. In another embodiment, the image type can be text, a sports program, a movie, a TV show, or another type of data that displays an image. A displayed image can be any type of image capable of being displayed. For example, a displayed image can be a photo, text, a movie, a TV show, etc.

After determining the displayed image type, a semi-transparent mask is selected that corresponds to the identified image type. For example, if the image type is text, a relatively opaque mask can be selected. Alternatively, a more transparent mask can be used for image data such as a photo or video data. The selected mask can then be used to modify the displayed image. This modifying of the displayed image step may include placing the selected mask over at least a portion of the displayed image.

Additionally, this embodiment includes a step of displaying a menu over a modified image. The menu can be navigated by a user via a scrolling cursor. For example, a user can navigate through one or more menu items of the menu via a cursor. A user also can select one or more menu items. In another embodiment, the menu items can be divided into at least two sets: a first set of menu items and a second set of menu items such as a set of categories and options. In this embodiment, the second set of menu items can correspond to at least one menu item of the first set of menu items.

When the Start Menu is used as an overlay, the user does not have to exit a displayed image or “current” page (e.g. a gallery) in order to find options the user may be interested in. With the Start menu overlay, the user views the Start Menu on top of whatever page the user happens to be viewing. From here, the user can navigate through the Start Menu. The “current” page or displayed image becomes the background for the Start Menu overlay, allowing the user to still see where the Start Menu was invoked from. Preferably, the readability of the menu is enhanced by overlaying a mask on top of the background image.

In another embodiment, a Details page or other lower level menu can be used as the overlay. For example, if a user wants to play an album or edit an album name, the user does not have to leave the gallery where the user has located and picked the specific album. Rather, by selecting the album, the user can receive a Details overlay that allows the user to achieve desired actions. In such an embodiment, the user can still see the context of the gallery as it is. However, the gallery is preferably moved into the background along the z-direction away from the user. A mask can also be applied to the gallery so that the gallery appears less transparent. This allows the user to stay in context of the “current” page and selection selected by the user.

In still another embodiment, an animation can occur when focus is placed in the pivot region or inset (picture in picture; PIP) where the gallery recedes in space at an angle. The pivot region or inset would move forward in space to demonstrate focus. If focus is moved within the pivot region by pressing left or right, the gallery in the background z-order can update to the appropriate gallery in focus.

Another type of animation to assist a user in understanding displayed information is modifying the appearance of images intended to serve as a background. For example, a user can view a movie or other type of video image on a display. Or a user can be viewing a gallery of items for a potential action, such as reviewing the content of one of the gallery items. During viewing of the movie, gallery, or other displayed image, the user may want to work with a menu to perform another action. The action may or may not be related to the current displayed image. In an embodiment, an overlay menu of potential desired actions can be displayed in the same viewing area as the other displayed image. This creates a situation where the overlay menu can be thought of as an image in the foreground, while the movie, gallery, or other displayed image is considered a background image.

Furthermore, according to this embodiment, the displayed image can be partitioned into several display areas. Pivot region or inset can occupy an upper portion of image, while the gallery occupies a lower portion. Pivot region or inset provides an area for displaying menu choices related to objects in gallery. When the pivot region or inset is selected, an animation can be used to tilt gallery by a few degrees around an axis that contains the lower right corner of gallery. This animation informs the user that pivot region or inset is currently active.

In an embodiment, a background image can be tilted away from the user by treating the background image as an image lying in a single plane, and pivoting the image around a fixed point or line. For example, one of the corners of the background image could be used as the fixed point. The plane containing the background image can then be rotated by a few degrees around an axis containing the fixed point. Alternatively, an edge of the background image, such as the bottom edge, can be used as a fixed line. The background image can then be rotated by a few degrees around an axis corresponding to the fixed line.

In an embodiment, the background image can be rotated about an axis by at least 2 degrees, or at least 3.5 degrees, or at least 5 degrees. In another embodiment, the background image can be rotated about an axis by 10 degrees or less, or 7.5 degrees or less, or 5 degrees or less. In still another embodiment, after the user finishes manipulating the overlay image, the background image can be restored to its original plane.

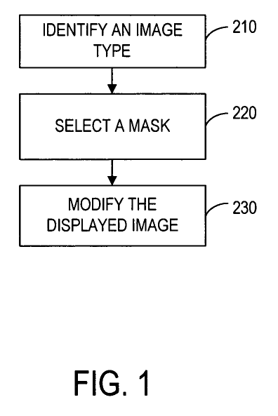

FIG. 1 provides an example of a method for displaying a menu. In FIG. 1, a processor with instructions identifies an image type 210 corresponding to a displayed image. Next, the processor selects a mask 220 corresponding to the image type. Lastly, the processor modifies the displayed image 230 using the selected mask. As a result, a user can view, navigate, and select menu items while being able to still view a displayed image in the background.

III. The Multimedia Processing System

In another embodiment, there is a multimedia processing system for enabling a user to navigate through media content while still viewing a displayed image in the background. In this embodiment, the multimedia processing system includes multiple components. These components include, but are not limited to, a controller for controlling the multimedia processing system; a processor for providing a multi-dimensional user interface on a display means coupled to the multimedia processing system; a user interface software module for providing a user interface shown on the display means; and a magnifier module for magnifying a selected menu item. This embodiment also enables a user to view, navigate, and select menu items while being able to still view a displayed image in the background. For example, a user could navigate through a details page menu with multiple menu items while viewing a photo being displayed in the background.

According to an embodiment, in order to provide fluidity between the various displays of the user interface based on user inputs, the media user interface may be animated. Because the user of the user interface is typically going to be located farther from the screen than a 2-Foot user interface, it is generally more difficult for a user to see smaller details on the user interface. Instead of instantly changing from one menu to the next, or from one menu item selection to the next, either of which a user might miss if not paying careful attention, animation may be used to illustrate to the user the result of his or her user input, or the changing of one menu to the next, thus making it easier for the user to conceptually follow his or her navigation through the user interface. Furthermore, animation may be used to provide feedback that a user has performed some action on the user interface, such as moving focus from one menu item to another or selecting an entirely new menu item.

In order to provide three-dimensionality and animations, the user interface may be developed using any software package that provides three-dimensionality and graphics acceleration, such as the DirectX® 9.0 software development kit with DirectX 9.0b runtime, available from Microsoft Corporation of Redmond, Wash. The underlying software architecture is secondary to the services it provides the media user interface. Microsoft's DirectX® is a suite of multimedia application programming interfaces (APIs) built into Microsoft's Windows® operating systems, and provides a standard development platform for Windows-based PCs by enabling software developers to access specialized hardware features without having to write hardware-specific code. The APIs act as a bridge for the hardware and the software to communicate. The DirectX® APIs give multimedia applications access to the advanced features of high-performance hardware such as three-dimensional (3-D) graphics acceleration chips and sound cards. The APIs also control low-level functions, including two-dimensional (2-D) graphics acceleration; support for input devices such as joysticks, keyboards, and mice; and control of sound mixing and sound output. Versions of DirectX® prior to versions 9.0 may also or alternatively be used.

Furthermore, according to this embodiment, this system is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

According to another aspect of this embodiment, components of the system may include a system memory, and a system bus that couples various system components including the system memory to the processor. The system bus may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Additionally, any embodiment may include a variety of computer readable media. Computer readable media can be any available media that can be accessed by the system and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the system. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory may include computer storage media in the form of volatile and/or nonvolatile memory such as read only memory (ROM) and random access memory (RAM). A basic input/output system (BIOS), containing the basic routines that help to transfer information between elements within the system, such as during start-up, is typically stored in ROM. RAM typically contains data and/or program modules that are immediately accessible to and/or presently being operated on by the processor.

The embodiment may also include other removable/non-removable, volatile/nonvolatile computer storage media. For example, a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the illustrative operating environment include, but are not limited to, magnetic tape cassettes, flash memory cards, digital versatile disks, digital video tape, solid state RAM, solid state ROM, and the like. The hard disk drive is typically connected to the system bus through an non-removable memory interface, and magnetic disk drive and optical disk drive are typically connected to the system bus by a removable memory interface.

The drives and their associated computer storage media, discussed above, provide storage of computer readable instructions, data structures, program modules and other data for the system. Additionally, a user may enter commands and information into the system through input devices such as a keyboard and pointing device, commonly referred to as a mouse, trackball or touch pad. Other input devices may include a microphone, joystick, game pad, satellite dish, scanner, or the like. These and other input devices are often connected to the processor through a user input interface that is coupled to the system bus, but may be connected by other interface and bus structures, such as a parallel port, game port or a universal serial bus (USB). A monitor or other type of display means (e.g., a TV) is also connected to the system bus via an interface, such as a video interface. In addition to the monitor, this system may also include other peripheral output devices such as speakers, which may be connected through an output peripheral interface.

Preferably, the controller of this embodiment is a remote control device.

However, the controller can be any controlling device internal or external to the system. In this embodiment, the processor generates and provides a multi-dimensional user interface using the computer executable software modules stored in the memory cells of the processor. The user interface software module provides animation-enhanced effects to some portions of the user interface. For example, the user interface may include one or more semi-transparent masks for laying over an image.

The magnifier module also enables the user to view animation enhanced effects. For example, the magnifier module magnifies the selected menu item by providing a motion sequence of frames of an animation when the user selects one or more menu items from a set of menu items. As a result, the magnifier module initiates the animation sequence to divide the one or more menu items between a first plane and a second plane and animates the first and second planes moving away from each other in three dimensional space. In other words, it appears to the user that the selected menu item is magnified in the z-direction towards the user.

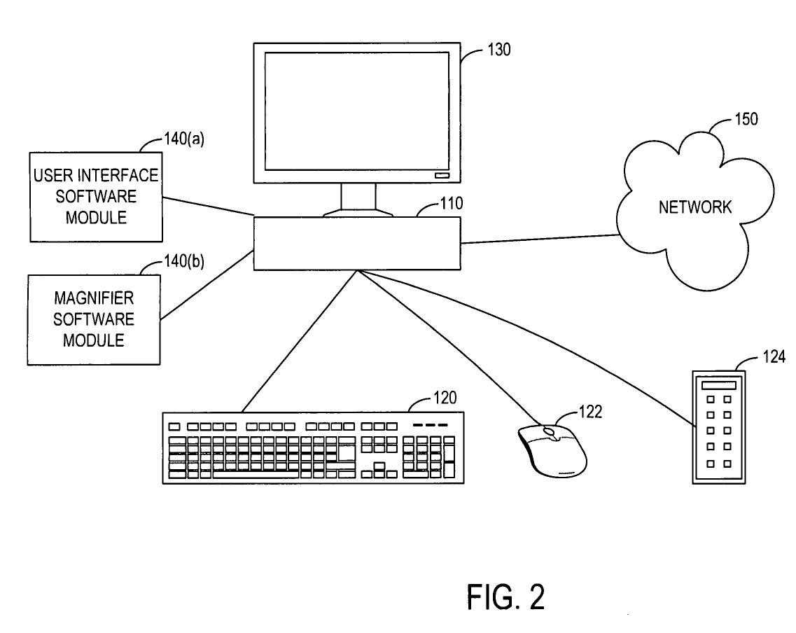

FIG. 2 provides an example of a computer system for enabling a user to navigate through media content while still viewing a displayed image in the background. In FIG. 2, a controller (not shown) controls the multimedia processing system. A processor 110 provides a user interface on a display means 130 coupled to the multimedia processing system a (not shown). A user interface software module 140(a) provides a user interface shown on the display means 130. And a magnifier module 140(b) magnifies a selected menu item. The computer system, in FIG. 2, can be configured to connect to a network 150. This network can be a local network or the Internet. The computer system can also have various input and output devices such as a key board 120 or mouse 120. Additionally, the computer system can have additional storage devices 124 such as a memory or database.

IV. The User Interface

In another embodiment, the invention provides a user interface for displaying a menu to a user. In this embodiment, the user interface comprises multiple components for achieving this result. These components include, but are not limited to, a menu mask laid over a displayed image; a first set of menu items; and a second set of menu items. This user interface can be stored as a computer executable instructions in a memory of a computer system.

In this embodiment, the menu mask is a semi-transparent mask. The processor with instructions from a software module selects a menu mask that corresponds to a displayed image. As a result, the selected menu mask is overlaid onto the displayed image.

The user interface further comprises multiple menu items. For example, a first set of menu items correspond to various types of menus such as a Start Menu or the Details Page. The first set of menu items permits a user to select a menu item at anytime with a selection cursor. The second set of menu items also correspond to various types of menus. Likewise, the second set of menu items permits a user to select a menu item at anytime with a selection cursor. However, in the case of the second set of menu items, each menu item in the second set of menu items can correspond to at least one menu item of the first set of menu items. The first set of menu items is listed and displayed in a vertical band. Similarly, the second set of menu items is listed and displayed in a horizontal band. A user may select and navigate via selection cursor one or more menu items of either the first set or second set of menu items.

In another embodiment, the mask can contain two portions for displaying a menu. The first portion is horizontal band portion. The second portion is a remaining portion. The remaining portion can include any content that is not displayed on the horizontal band portion. Preferably, the horizontal band is relatively opaque. In other words, the horizontal band is preferably more opaque and has a higher intensity than the remaining portion. The horizontal band can include the contents of the second set of menu item. In such an embodiment, the remaining portion has a lower intensity and is less visible when the horizontal band is active. For example, the intensity can be 1 times, 2 times, 2.5 times, or 3 times higher than the remaining portion.

Additionally, this embodiment would allow for a third set of menu items, fourth set of menu items, etc. In this case, each consecutive set of menu items would correspond to a previous set of menu items. For example, a third set of menu items would correspond to at least one menu item of the second set of menu items.

The user interface for this embodiment may include a plurality of high level menu items, a list (of text, icons, graphics, etc.) of most recently used menu items, a power menu icon, and a clock. High level menu items may include options for Online Spotlight, My Pictures, My Videos, My TV, My Music, My Radio, My Programs, My Tasks, and Settings. Other high level items may also or alternatively be included. A list of menu items may include up to the three most recent user-selected menu items corresponding to the currently highlighted menu item. For example, when a My TV menu item is highlighted, the menu items might include media selections for DVD, TV, or Movies; when a My Music menu item is highlighted, the menu item list might include the three most recent songs played by the user; when the My Radio menu item is highlighted, the menu item list might include the three most recent radio stations listed to by the user; etc. As the user moves the control cursor over a new menu item, the user interface software application refreshes the menu item list to correspond to the newly highlighted menu items. If the user has never selected three media items corresponding to the current menu item, the user interface application may alternatively cause the user interface to display default items or action, or no items at all in the menu item list.

According to an aspect of this embodiment, the menu item list might contain icons or graphics, or text, or a combination of the two. Icons are preferably used, with or without text, as visual stimulation is more easily perceived and recognized from distances (such as are typical in use with a 10-Foot user interface) than is text. In order to perceive and recognize text at the same distance, the text would necessarily be quite large and take up more display real estate than is necessary for graphics or icons. Thus, a combination of text and graphics suits the media user interface for use as a 10-Foot user interface as well as a 2-Foot user interface.

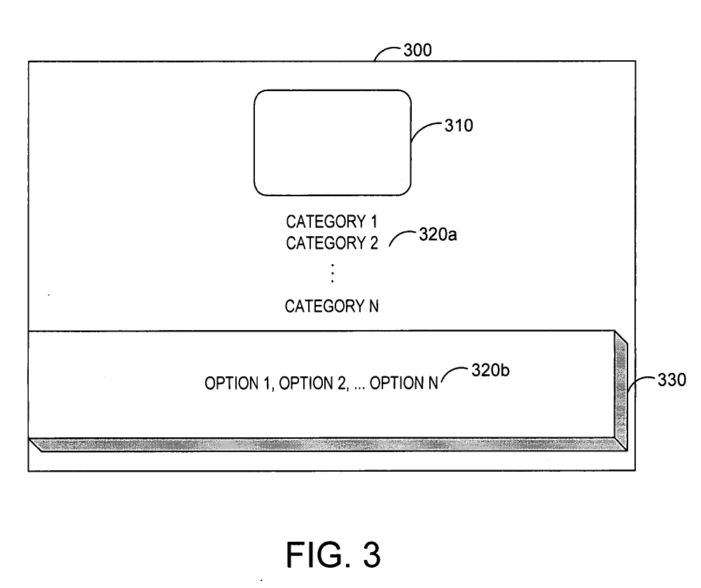

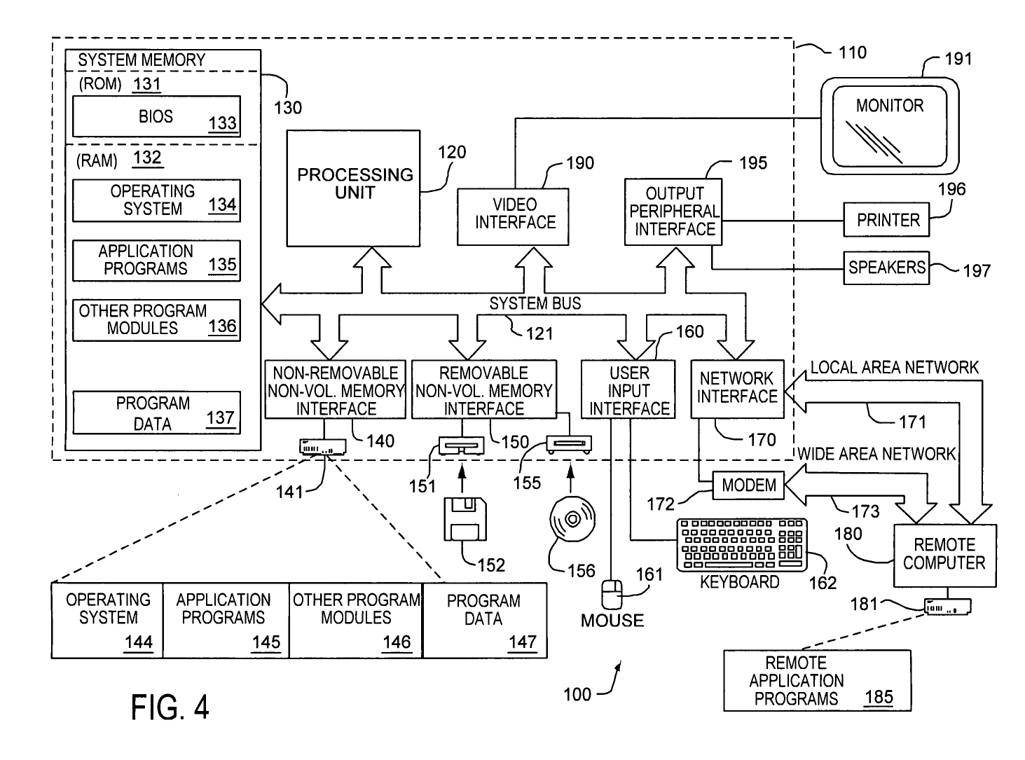

FIG. 3 provides an example of a user interface 420 for enabling a user to navigate through media content while still viewing a displayed image in the background. In FIG. 3, the user interface 300 comprises a masked image 310(e.g. a mask laid over a displayed image); a first set of menu items 320a; and a second set of menu items 320b. The user interface can also comprise a vertical bar 330, on which, the second set of menu items 320b are listed and displayed. The user interface 300 can be stored as computer executable instructions on a computer readable medium.

The principles and modes of operation of this invention have been described above with reference to various exemplary and preferred embodiments. As understood by those of skill in the art, the overall invention, as defined by the claims, encompasses other preferred embodiments not specifically enumerated herein.

We claim:

1. A method for displaying a menu to a user, comprising the steps of:
identifying an image type corresponding to a displayed image;
selecting a mask corresponding to the image type;
modifying the displayed image using the selected mask.

2. The method according to claim 1, wherein the modifying step further comprises: placing the selected mask over a portion of the displayed image.

3. The method according to claim 1, wherein the mask is semi-transparent.

4. The method according to claim 1, wherein the identifying step further comprises: determining whether the displayed image is selected from the group consisting of text data or image data.

5. The method according to claim 1, further comprising: displaying a menu over the modified image.

6. The method according to claim 1, further comprising: navigating through one or more menu items of the menu via a cursor.

7. The method according to claim 6, wherein the menu includes one or more menu items selectable by a user.

8. The method according to claim 7, wherein the menu items has a first set of menu items selectable by a user.

9. The method according to claim 8, wherein the menu items has a second set of menu items selectable by a user corresponding to the first set of menu items.

10. The method according to claim 1, wherein a user can access other applications while simultaneously experiencing the displayed image.

11. The method according to claim 1, further comprising: identifying a pivot axis, the pivot axis having one or more points in common with a background image; and tilting the image around the pivot axis by at least 3.5 degrees.

12. The method according to claim 1, further comprising: selecting a pivot region corresponding to an animation for tilting a gallery by at least 2 degrees.

13. A user interface stored as computer executable instructions in a memory of a computer system, the user interface comprising:
a displayed image;
a menu mask overlaid onto a displayed image, the menu mask being selected based on the displayed image;
a first set of menu items selectable using a selection cursor; and
a second set of menu items corresponding to at least one menu item of the first set, the second set of menu items being selectable using the selection cursor.

14. The user interface according to claim 13, wherein the first set of menu items is listed and displayed in a vertical band.

15. The user interface according to claim 13, wherein the second set of menu items is listed and displayed in a horizontal band.

16. The user interface according to claim 13, wherein the mask contains a horizontal band that is more opaque and has at least a 1.5 times higher intensity than a remaining portion.

17. The user interface according to claim 13, wherein one or more menu items of the first set and of the second set selected by a user navigable by a selection cursor.

18. The user interface according to claim 13, further comprising: a magnifier module for magnifying a selected menu item.

19. The multimedia processing system according to claim 18, wherein the magnifier module magnifies the selected menu item by providing a motion sequence of frames of an animation when the user selects the one or more menu items from a first set of menu items, and the sequence divides the one or more menu items between a first plane and a second plane and animates the first and second planes moving away from each other in three dimensional space.
